(19) United States
(12) Patent Application Publication
(10) Pub. No.: US 2025/0168277 A1
(43) Pub. Date: May 22, 2025

(54) REPORT ASSISTING DEVICE, COMMUNICATION TERMINAL, REPORT ASSISTING METHOD, AND COMPUTER READABLE STORAGE MEDIUM

(71) Applicant: NEC Corporation, Minato-ku, Tokyo (JP)

(72) Inventors: Takeshi HISHIYAMA, Tokyo (JP); Tetsuhiro TSUNODA, Tokyo (JP); Toshihiro ENDO, Tokyo (JP)

(73) Assignee: NEC Corporation, Minato-ku, Tokyo (JP)

(21) Appl. No.: 18/839,517

(22) PCT Filed: Feb. 22, 2022
(86) PCT No.: PCT/JP2022/007279

§ 371 Date: Aug. 19, 2024

(51) Int. Cl. H04M 3/42

(52) U.S. Cl. CPC H04M 3/42348; H04M 2201/40

(57) ABSTRACT

A report assisting device according to an aspect of the present disclosure includes: a detector that detects a report from a communication terminal, the report causing a communication using telephone conversations between the communication terminal and a report destination to be initiated; an acquisition circuit that acquires the position information of the communication terminal when the report is detected; and a display controller that controls the communication terminal to display the acquired position information.

### TECHNICAL FIELD

The present disclosure relates to a technique for assisting a response at the time of report.

### BACKGROUND ART

When an accident or the like occurs, a person at the site of the accident makes an emergency report to a police station, a fire department, or the like according to a situation. An operator in a command room who has received the emergency report normally grasps the situation by a speech from the reporter.

In relation to grasping of a situation at the time of emergency report, PTL 1 discloses a technique for transmitting determined position information in a communication terminal device to a communication partner in a case where an emergency call is made from the communication terminal device.

In relation to a technique for transmitting information, PTL 2 discloses a technique for transmitting various types of information from a mobile phone that has made an emergency report to a mobile phone that has received the emergency report. Specifically, in the technique disclosed in PTL 2, information such as the name of the owner of a mobile phone is accumulated in advance, and in a case where an emergency report is made from the mobile phone, the accumulated information such as the name is transmitted to a mobile phone as a report destination.

### CITATION LIST

### Patent Literature

PTL 1: JP 2009-100391 A
PTL 2: JP 2012-044438 A

### SUMMARY OF INVENTION

### Technical Problem

An operator of a command room which is the report destination of the emergency report may request the dispatch of police officers, fire brigades, ambulance teams, or the like. Therefore, the operator is required to quickly specify the position of the site where the accident or the like has occurred, which is the dispatch destination. In order to specify the position of the site, it is conceivable that the operator asks the reporter for the position of the site. However, if the reporter does not know the position (that is, the current location) where he/she is or falls into panic, the reporter may not be able to accurately convey information to the operator.

In response to this, it is conceivable that the communication terminal used by the reporter automatically transmits data indicating its own position to the report destination. However, an emergency report is often made by telephone conversations, and in such a communication in which an emergency report is made, it is not always possible to transmit the data indicating the position. In order for the communication terminal to transmit the data indicating the position, it may be necessary to use communication different from the communication in which the emergency report is made.

The present disclosure has been made in view of the above problems, and an object thereof is to provide a report assisting device and the like that can assist an appropriate conveying of position information to a report destination. Solution to Problem

A report assisting device according to an aspect of the present disclosure includes: a detection means for detecting a report from a communication terminal, the report causing a communication using telephone conversations between the communication terminal and a report destination to be initiated; an acquisition means for acquiring position information of the communication terminal in a case where the report is detected; and a display control means for controlling the communication terminal to display the acquired position information.

A communication terminal according to an aspect of the present disclosure includes: a detection means for detecting a report from a communication terminal, the report causing a communication using telephone conversations between the communication terminal and a report destination to be initiated; an acquisition means for acquiring position information of the communication terminal in a case where the report is detected; and a display control means for controlling the communication terminal to display the acquired position information.

A report assisting method according to an aspect of the present disclosure includes: detecting a report from a communication terminal, the report causing a communication using telephone conversations between the communication terminal and a report destination to be initiated; acquiring position information of the communication terminal in a case where the report is detected; and controlling the communication terminal to display the acquired position information.

A computer readable storage medium according to an aspect of the present disclosure has stored thereon a program that causes a computer to execute: detecting a report from a communication terminal, the report causing a communication using telephone conversations between the communication terminal and a report destination to be initiated; acquiring position information of the communication terminal in a case where the report is detected; and controlling the communication terminal to display the acquired position information. Advantageous Effects of Invention

According to the present disclosure, it is possible to assist an appropriate conveying of position information to a report destination.

### BRIEF DESCRIPTION OF DRAWINGS

FIG. 1 is a diagram schematically illustrating an example of a report mechanism of the present disclosure.

FIG. 2 is a block diagram illustrating an example of a functional configuration of a report assisting device according to a first example embodiment of the present disclosure.

FIG. 3 is a flowchart illustrating an example of an operation of the report assisting device according to the first example embodiment of the present disclosure.

FIG. 4 is a diagram schematically illustrating an example of a configuration including a report assisting device according to a second example embodiment of the present disclosure.

FIG. 5 is a block diagram illustrating an example of a functional configuration of the report assisting device according to the second example embodiment of the present disclosure.

FIG. 6 is a diagram illustrating an example of display of position information according to the second example embodiment of the present disclosure.

FIG. 7 is a flowchart illustrating an example of an operation of the report assisting device according to the second example embodiment of the present disclosure.

FIG. 8 is a block diagram illustrating an example of a functional configuration of a report assisting device according to a second modification of the present disclosure.

FIG. 9 is a block diagram illustrating an example of a functional configuration of a report assisting device according to a third example embodiment of the present disclosure.

FIG. 10 is a diagram illustrating an example of request information according to the third example embodiment of the present disclosure.

FIG. 11 is a flowchart illustrating an example of an operation of the report assisting device according to the third example embodiment of the present disclosure.

FIG. 12 is a block diagram illustrating an example of a hardware configuration of a computer device that achieves the report assisting devices according to the first, second, and third example embodiments of the present disclosure.

### EXAMPLE EMBODIMENT

Hereinafter, example embodiments of the present disclosure will be described with reference to the drawings.

### First Example Embodiment

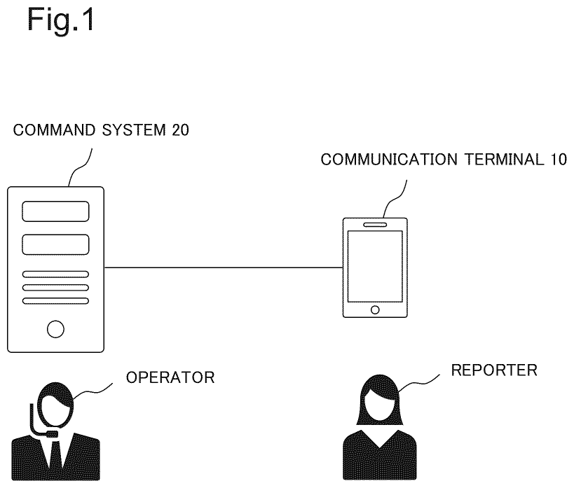

First, a report mechanism will be described. FIG. 1 is a diagram schematically illustrating an example of a report mechanism. A reporter makes a report by inputting a predetermined telephone number or the like using a communication terminal 10. The communication terminal 10 is, for example, a mobile terminal such as a mobile phone, a smartphone, and a tablet terminal. The communication terminal 10 is not limited to this example, and may be a personal computer.

The report is connected to a command system 20 in a command room. The command room indicates an organization that issues a dispatch command to a target to be dispatched to a site (for example, a police officer, a fire brigade, an ambulance team, or the like) according to the content of the report. The operator in the command room conducts telephone conversations with the reporter via the command system 20. Then, the operator gives an instruction to the reporter based on the information obtained from the reporter, or gives an instruction to the target to be dispatched to the site by using the command system 20. A report assisting device of the present disclosure is used, as an example, in a situation where a such report is made.

Next, an outline of the report assisting device of the present disclosure will be described.

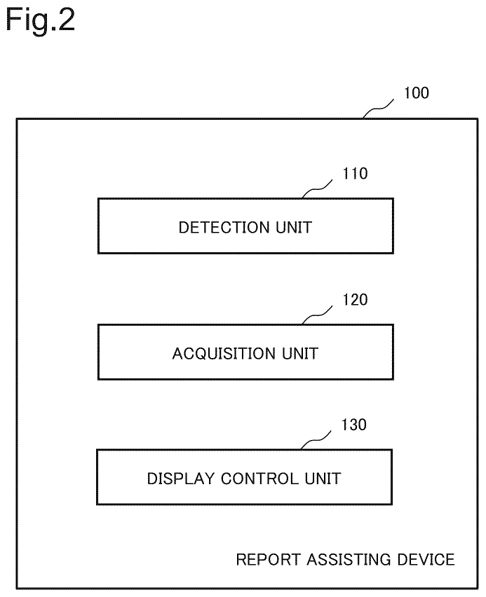

FIG. 2 is a block diagram illustrating an example of a functional configuration of a report assisting device 100. The report assisting device 100 is provided in the communication terminal 10, for example.

In the present disclosure, an example in which the report assisting device 100 is provided in the communication terminal 10 will be mainly described. The report assisting device 100 is not limited to this example, and may be a device external to the communication terminal 10 and communicably connected to the communication terminal 10 via a wired or wireless network.

As illustrated in FIG. 2, the report assisting device 100 includes a detection unit 110, an acquisition unit 120, and a display control unit 130.

The detection unit 110 detects a report from the communication terminal 10. With this report, a communication using telephone conversations between the communication terminal 10 and the report destination is initiated. The report destination is, for example, the command system 20 in the command room. As described above, the detection unit 110 detects a report from the communication terminal 10, the report causing the communication using telephone conversations between the communication terminal 10 and the report destination to be initiated. The detection unit 110 is an example of the detection means.

When the report is detected, the acquisition unit 120 acquires the position information of the communication terminal 10. The acquisition unit 120 acquires, for example, positioning information that is information obtained by determining a location where the communication terminal 10 is positioned. The positioning information may be information determined by using an external system. The acquisition unit 120 acquires, for example, the positioning information as position information. The acquisition unit 120 may acquire, as the position information, information indicating a place where the communication terminal 10 is positioned, the place being specified based on the positioning information. The position information may be indicated by, for example, latitude and longitude, or may be indicated by an address. The present invention is not limited to this example, and it is sufficient if the position information is information indicating the place where the communication terminal 10 is positioned. As described above, the acquisition unit 120 acquires the position information of the communication terminal 10 in a case where the report is detected. The acquisition unit 120 is an example of the acquisition means.

The display control unit 130 displays the position information. For example, the display control unit 130 performs control to display the position information acquired by the acquisition unit 120 on the communication terminal 10. At this time, the position information is displayed on a display device such as a display provided in the communication terminal 10, for example. As described above, the display control unit 130 performs control to display the acquired position information on the communication terminal 10. The display control unit 130 is an example of the display control means.

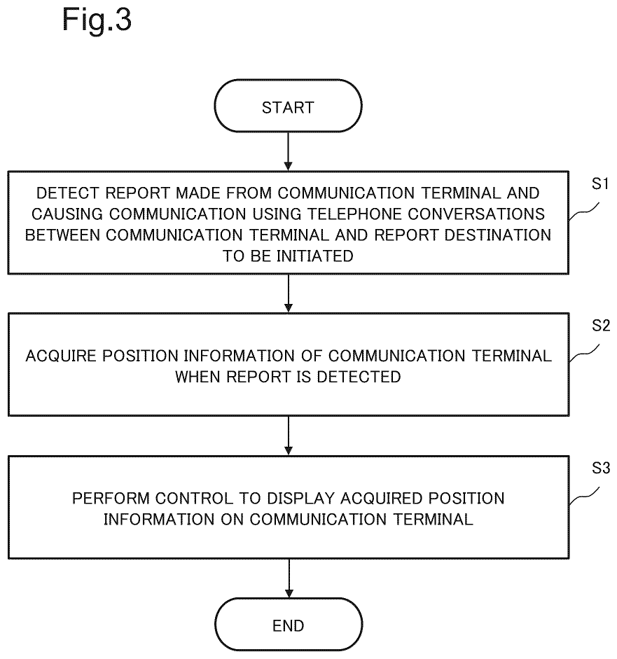

Next, an example of an operation of the report assisting device 100 will be described with reference to FIG. 3. In the present disclosure, each step of a flowchart is expressed by using a number, such as “S1”, which is assigned to each step.

FIG. 3 is a flowchart illustrating an example of the operation of the report assisting device 100. The detection unit 110 detects a report made from the communication terminal 10 and causing the communication using telephone conversations between the communication terminal 10 and the report destination to be initiated (S1). In a case where the report is detected, the acquisition unit 120 acquires the position information of the communication terminal 10 (S2). The display control unit 130 performs control to display the acquired position information on the communication terminal 10 (S3).

As described above, the report assisting device 100 according to the first example embodiment detects a report from the communication terminal 10, the report causing the communication using telephone conversations between the communication terminal 10 and the report destination to be initiated, and acquires position information of the communication terminal 10 in a case where the report is detected. Then, the report assisting device 100 performs control to display the acquired position information on the communication terminal 10. Accordingly, the report assisting device 100 enables the reporter to grasp the position information. Therefore, even in a state where a current location is unknown, the reporter can convey the current location to the report destination only by reading out the position information displayed on the communication terminal 10. The conveying can be performed without establishing a communication other than the communication using the report between the communication terminal 10 and the report destination. Therefore, the report assisting device 100 according to the first example embodiment can assist an appropriate conveying of the position information to the report destination.

### Second Example Embodiment

Next, a report assisting device according to a second example embodiment will be described. In the second example embodiment, the report assisting device 100 described in the first example embodiment will be described in more detail. Note that description of contents overlapping with the contents described in the first example embodiment will be partially omitted.

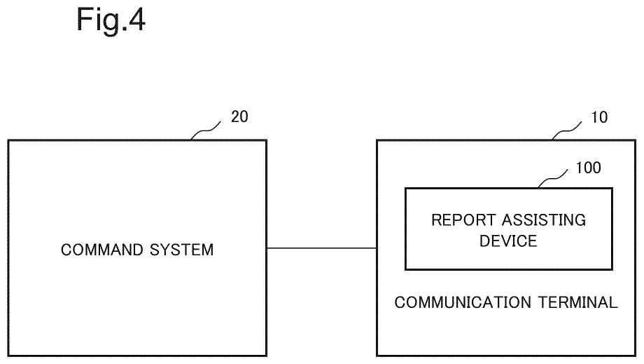

FIG. 4 is a diagram schematically illustrating an example of a configuration including the report assisting device 100. As illustrated in FIG. 4, for example, the report assisting device 100 is provided in the communication terminal 10.

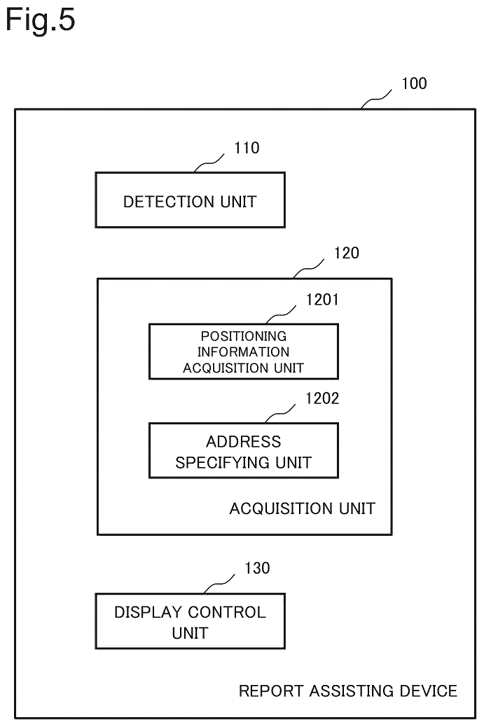

FIG. 5 is a block diagram illustrating an example of a functional configuration of the report assisting device 100. As illustrated in FIG. 5, the report assisting device 100 includes a detection unit 110, an acquisition unit 120, and a display control unit 130.

The detection unit 110 detects a report from the communication terminal 10. The detection unit 110 may detect the report before the communication between the communication terminal 10 and the command system 20 as the report destination is established, or may detect the report after a time point when the communication is established. For example, it is assumed that the reporter inputs a telephone number of an emergency report destination and makes a report using a telephone line. That is, it is assumed that a report is made to cause a communication via a telephone line between the communication terminal 10 and the command system 20 as the report destination to be initiated.

In this case, for example, the communication terminal 10 makes a call to the command system 20. At this time, the detection unit 110 determines whether the input telephone number is an emergency report destination. Then, in a case where the input telephone number is an emergency report destination, the detection unit 110 may detect the call made by the communication terminal 10 as a report from the communication terminal 10. In a case where the input telephone number is an emergency report destination and the report destination receives a call (that is, in a case where a communication of a telephone line is established between the communication terminal 10 and the command system 20), the detection unit 110 may detect the report.

A method of determining whether the input telephone number is an emergency report destination is implemented by various methods. For example, the detection unit 110 may determine whether the input telephone number is a telephone number for emergency report. The telephone number for emergency report is a telephone number defined in each country, and is a telephone number for reporting an incident, an accident, and the like. The present invention is not limited to this example, and at least one or more telephone numbers may be predetermined as the emergency report destination. The detection unit 110 may determine whether the input telephone number is the predetermined telephone number of the emergency report destination.

The acquisition unit 120 includes a positioning information acquisition unit 1201 and an address specifying unit 1202. The positioning information acquisition unit 1201 acquires positioning information from the communication terminal 10. The positioning information may be information determined by a global navigation satellite system (GNSS) such as a global positioning system (GPS). The communication terminal 10 has a function of determining a location where the communication terminal 10 is positioned. As described above, the positioning information acquisition unit 1201 acquires positioning information that is information obtained by determining a location where the communication terminal 10 is positioned. The positioning information acquisition unit 1201 is an example of the positioning information acquisition means.

The address specifying unit 1202 specifies an address based on the positioning information. For example, it is assumed that map information is stored in a storage device (not illustrated) included in the report assisting device 100 or the communication terminal 10. The map information is information in which positioning information and an address are associated with each other. For example, the address specifying unit 1202 specifies, from the map information, an address corresponding to the positioning information acquired by the positioning information acquisition unit 1201. The specified address indicates an address where the communication terminal 10 is positioned. As described above, the address specifying unit 1202 specifies the address where the communication terminal 10 is positioned, based on the positioning information. The address specifying unit 1202 is an example of the address specifying means.

As described above, the acquisition unit 120 may acquire the positioning information as the position information, or may acquire the specified address as the position information.

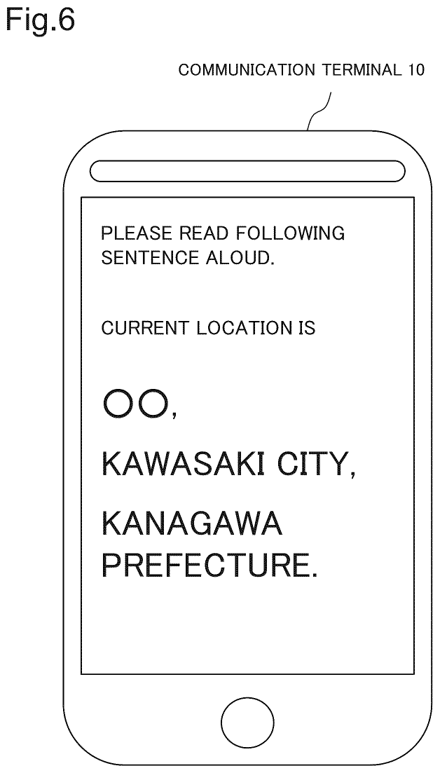

The display control unit 130 performs control to display the position information on the communication terminal 10. FIG. 6 illustrates an example of display of the position information. In the example of FIG. 6, an address is displayed as the position information on the display of the communication terminal 10. In this example, an address “oo, Kawasaki City, Kanagawa Prefecture” is displayed to be larger than other character information. As described above, the display control unit 130 may display the position information in a more emphasized manner than other character information. The reporter may fall into a panic. In response to this, by displaying the position information in an emphasized manner, it is possible to make it easy for the reporter to focus on the position information. The method of emphasizing the position information is not limited to this example. For example, the display control unit 130 may color the position information, change the font of the position information, or add a figure around the position information. In addition, as illustrated in FIG. 6, the display control unit 130 may display the Chinese characters of the position information around the position information.

### [Operation Example of Report Assisting Device 100]

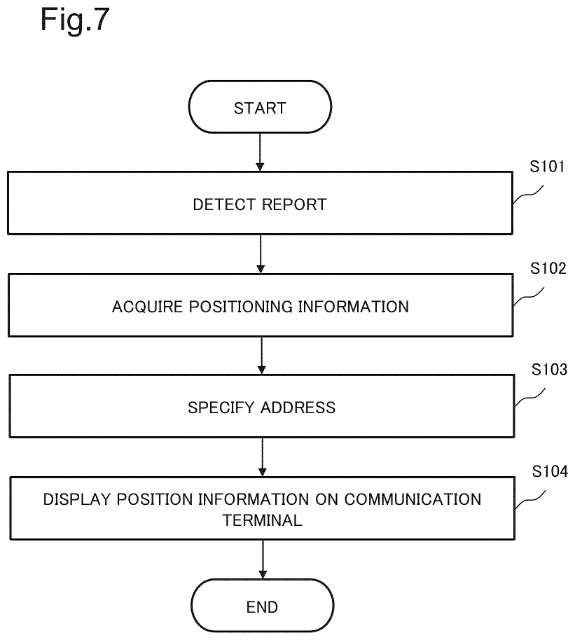

Next, an example of an operation of the report assisting device 100 will be described with reference to FIG. 7.

FIG. 7 is a flowchart illustrating an example of the operation of the report assisting device 100. First, the detection unit 110 detects a report by the communication terminal 10 (S101). The positioning information acquisition unit 1201 acquires positioning information obtained by determining a location where the communication terminal 10 is positioned (S102). The address specifying unit 1202 specifies an address where the communication terminal 10 is positioned, based on the positioning information (S103). For example, the address specifying unit 1202 specifies an address corresponding to the positioning information, based on the map information. Then, the display control unit 130 displays the position information on the communication terminal 10 (S104). For example, the display control unit 130 displays the specified address as the position information.

As described above, the report assisting device 100 according to the second example embodiment detects a report from the communication terminal 10, the report causing a communication using telephone conversations between the communication terminal 10 and the report destination to be initiated, and acquires position information of the communication terminal 10 in a case where the report is detected. Then, the report assisting device 100 performs control to display the acquired position information on the communication terminal 10. Accordingly, the report assisting device 100 enables the reporter to grasp the position information. Therefore, even in a state where a current location is unknown, the reporter can convey the current location to the report destination only by reading out the position information displayed on the communication terminal 10. The conveying can be performed without establishing a communication other than the communication using the report between the communication terminal 10 and the report destination. Therefore, the report assisting device 100 according to the first example embodiment can assist an appropriate conveying of the position information to the report destination.

The report assisting device 100 according to the second example embodiment may acquire positioning information that is information obtained by determining a location where the communication terminal 10 is positioned, and may specify an address where the communication terminal 10 is positioned, based on the positioning information. Then, the report assisting device 100 may display the specified address as the position information on the communication terminal 10. Accordingly, the report assisting device 100 can display information that is easy for the reporter to convey and is easy for the operator of the report destination to understand.

### [First Modification]

A process of specifying the address based on the positioning information is not limited to the above example. For example, it is assumed that map information in which positioning information and an address are associated with each other is stored in an external device capable of communicating with the report assisting device 100. In this case, when the positioning information acquisition unit 1201 acquires the positioning information of the communication terminal 10, the address specifying unit 1202 transmits the acquired positioning information to the external device. The external device converts the transmitted positioning information into a corresponding address. Then, the external device transmits information indicating the converted address to the communication terminal 10 or the report assisting device 100. The address specifying unit 1202 may specify the address corresponding to the positioning information by receiving information indicating the address transmitted by the external device.

### [Second Modification]

In the communication terminal 10, there is a possibility that a function of determining a location where the communication terminal 10 is positioned by using GNSS or the like is not activated. At this time, the report assisting device 100 may activate the function of the communication terminal 10.

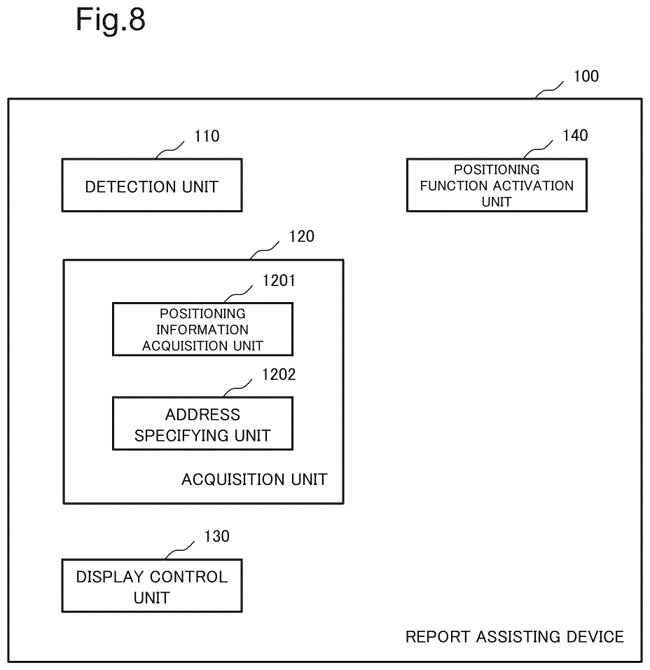

FIG. 8 is a block diagram illustrating an example of a functional configuration of the report assisting device 100 according to a second modification. As illustrated in FIG. 8, the report assisting device 100 may include a positioning function activation unit 140 in addition to the detection unit 110, the acquisition unit 120, and the display control unit 130.

In a case where the function of determining the location where the communication terminal 10 is positioned is not activated in the communication terminal 10, the positioning function activation unit 140 activates the function. The positioning function activation unit 140 is an example of the positioning function activation means. The positioning information acquisition unit 1201 acquires the positioning information after the positioning function is activated.

Before the positioning function activation unit 140 activates the positioning function, the display control unit 130 may display information requesting agreement regarding the activation of the positioning function. For example, the display control unit 130 displays a sentence “If you agree to activation of a positioning function, please press ‘agree’” and a button indicating agreement. Then, in a case where the agreement button is selected by the reporter, the positioning function activation unit 140 may activate the positioning function.

### Third Example Embodiment

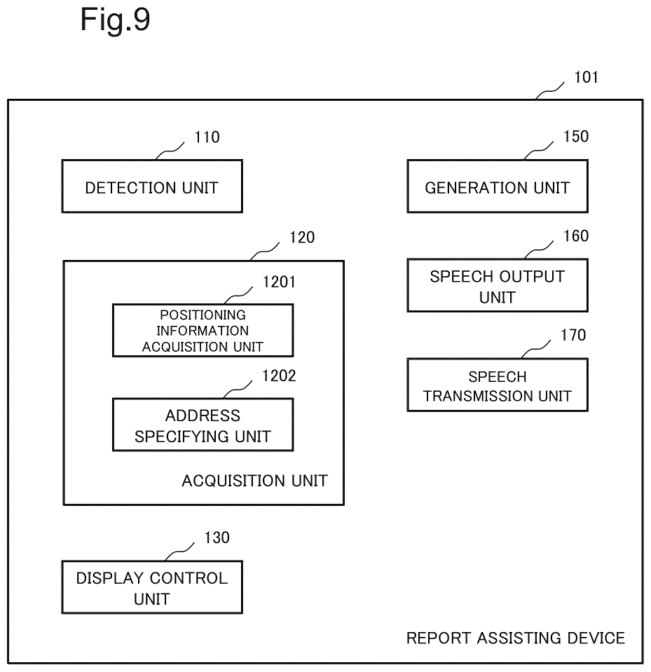

Next, a report assisting device according to a third example embodiment will be described. In the third example embodiment, another example of a method of outputting the position information will be mainly described. Note that description of contents overlapping with the contents described in the first and second example embodiments will be partially omitted.

[Details of Report Assisting Device 101]FIG. 9 is a block diagram illustrating an example of a functional configuration of a report assisting device 101. The report assisting device 101 is provided in the communication terminal 10. That is, in the third example embodiment, the report assisting device 101 is provided instead of the report assisting device 100 in the configuration illustrated in FIG. 4.

As illustrated in FIG. 9, the report assisting device 101 includes the detection unit 110, the acquisition unit 120, the display control unit 130, a generation unit 150, a speech output unit 160, and a speech transmission unit 170.

The generation unit 150 generates speech information. More specifically, the generation unit 150 generates speech information indicating the position information acquired by the acquisition unit 120. For example, the generation unit 150 generates speech information by performing speech synthesis processing on the text indicating the position information. That is, the speech information is a speech signal indicating the position information. For example, in a case where the position information indicates “Kawasaki City, Kanagawa Prefecture”, the speech information includes a speech indicating “Kawasaki City, Kanagawa Prefecture”.

Here, the speech synthesis processing may be, for example, text-to-speech (TTS). That is, the speech synthesis processing may be processing of performing language analysis processing such as morphological analysis on the text indicating the position information, and generating the waveform of the speech signal based on the phonological information generated by the language analysis processing and the prosody information based on the information regarding the pronunciation and the like. The speech synthesis processing is not limited to this example, and may be a known method. The speech synthesis processing may be processing in which speech information that is a speech signal indicating position information is generated.

As described above, the generation unit 150 generates the speech information indicating the position information. The generation unit 150 is an example of the generation means.

The speech output unit 160 outputs the speech information generated by the generation unit 150. Specifically, the speech output unit 160 causes a device, which is capable of outputting a speech, such as a speaker included in the communication terminal 10 to output the speech information. The output speech information is collected by a sound collection device such as a microphone included in the communication terminal 10. That is, the speech information output from the communication terminal 10 by the speech output unit 160 is conveyed to the command system 20 as the report destination via the sound collection device of the communication terminal 10. As described above, the speech output unit 160 outputs the generated speech information in the communication terminal 10. The speech output unit 160 is an example of the speech output means.

The speech transmission unit 170 transmits the speech information generated by the generation unit 150. Specifically, the speech transmission unit 170 transmits the speech information as the speech collected by the sound collection device included in the communication terminal 10 to the command system 20 as the report destination. As described above, the speech transmission unit 170 transmits the generated speech information to the report destination of the report as the speech collected by the communication terminal 10. The speech transmission unit 170 is an example of the speech transmission means.

Here, a difference between the conveying of the speech information to the report destination by the speech output unit 160 and the conveying of the speech information to the report destination by the speech transmission unit 170 will be described. In the conveying of the speech information by the speech output unit 160, the speech output from the communication terminal 10 is collected by the sound collection device of the communication terminal 10. At this time, since the reporter and the operator are in telephone conversations, the collected speech is conveyed to the report destination by using, for example, a communication via a telephone line. On the other hand, in the conveying of the speech information by the speech transmission unit 170, the generated speech information is conveyed to the report destination by using the communication via the telephone line as the speech collected by the sound collection device. That is, the generated speech information is directly transmitted to the report destination without being output in the communication terminal 10.

Since the conveying of the speech information by the speech output unit 160 is performed via the sound collection device of the communication terminal 10, there is a possibility that noise is included in the speech information transmitted to the report destination. Since in the conveying of the speech information by the speech transmission unit 170, the speech information is directly transmitted to the report destination, the possibility that noise is included in the speech information transmitted to the report destination is reduced.

Both the conveying of the speech information by the speech output unit and the conveying of the speech information by the speech transmission unit 170 may be performed, or either one may be performed. In a case where both the conveying of the speech information by the speech output unit and the conveying of the speech information by the speech transmission unit 170 are performed, the timings at which the conveying is performed may be different.

The display control unit 130 may cause request information for requesting agreement regarding provision of the position information to be displayed. As described above, the speech information indicating the position information is conveyed to the report destination. That is, the position information of the reporter is provided to the report destination by some method. Therefore, the display control unit 130 may request agreement as to whether the position information of the reporter may be provided to the outside. The request information is information to be displayed to request agreement. The display control unit 130 causes the request information to be displayed, for example, before the position information is displayed. The present invention is not limited thereto, and the display control unit 130 may display the request information before the conveying of the speech information by the speech output unit 160 or the conveying of the speech by the speech transmission unit 170 is performed. In addition, the display control unit 130 may cause the request information to be displayed before the processing of specifying the address by using the external device is performed as described in the first modification.

Then, the display control unit 130 receives an input indicating agreement or disagreement. That is, in a case where the input of agreement is received, the display control unit 130 may display the position information. In addition, in a case where the input of agreement is received, the generation unit 150 may generate speech information. In addition. In a case where the input of agreement is received, the conveying of the speech information by the speech output unit 160 or the conveying of the speech information by the speech transmission unit 170 may be performed. In addition, in a case where the input of agreement is received, the address specifying unit 1202 may perform processing of specifying the address by using the external device. In a case where the input of agreement is received, the display control unit 130 may not display the request information again thereafter.

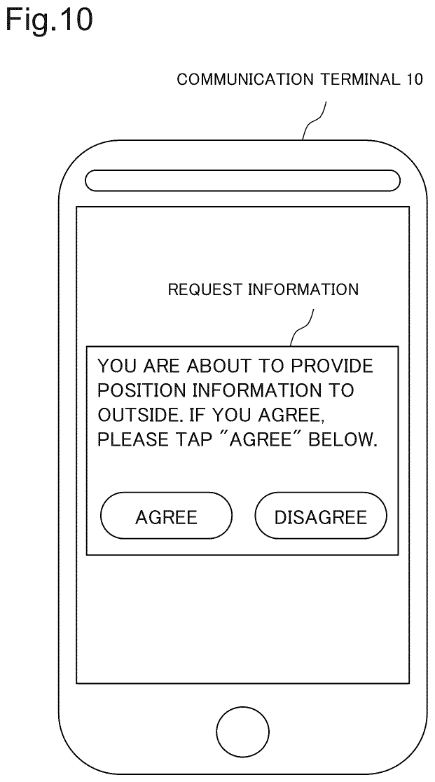

FIG. 10 is a diagram illustrating an example of the request information. In the example of FIG. 10, a sentence asking whether to agree to the provision of the position information is displayed on the display of the communication terminal 10. In addition, a button labeled with “agree” and a button labeled with “disagree” are displayed. The display control unit 130 displays the request information, and receives an input of agreement or an input indicating disagreement. In the example of FIG. 10, in a case where the “agree” button is selected, the display control unit 130 receives the input of agreement. In a case where the “disagree” button is selected, the display control unit 130 receives the input indicating disagreement.

### [Operation Example of Report Assisting Device 101]

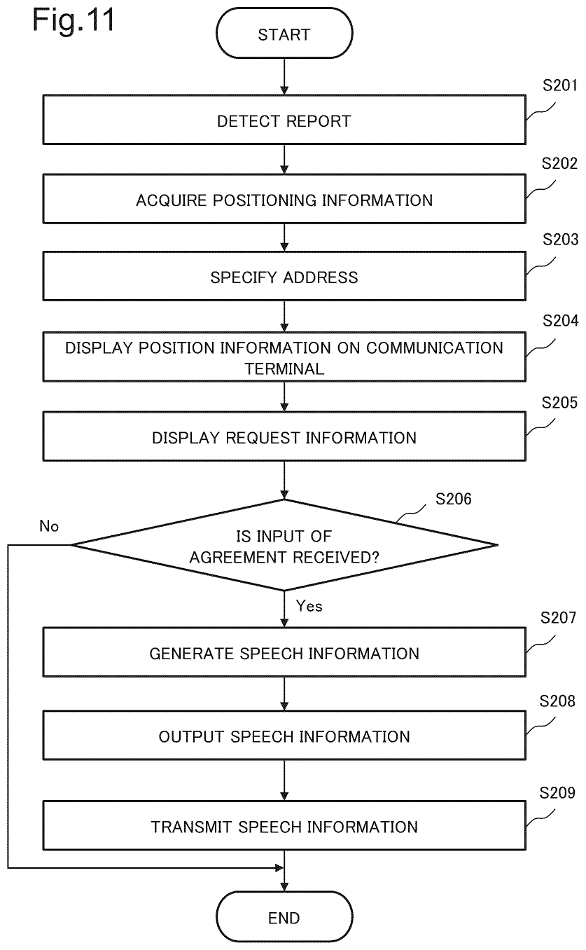

Next, an example of an operation of the report assisting device 101 will be described with reference to FIG. 11.

FIG. 11 is a flowchart illustrating an example of the operation of the report assisting device 101. The processing of S201 to S204 is similar to the processing of S101 to S104 of FIG. 7, and thus description thereof is omitted. The display control unit 130 displays, on the communication terminal 10, request information for requesting agreement regarding provision of the position information (S205). Then, if the display control unit 130 receives an input of agreement (“Yes” in S206), the generation unit 150 generates speech information indicating the position information (S207). Then, the speech output unit 160 outputs the speech information in the communication terminal 10 (S208). The speech transmission unit 170 transmits the generated speech information to the report destination (S209). On the other hand, if the display control unit 130 does not receive an input of agreement, that is, receives an input indicating disagreement (“No” in S206), the report assisting device 101 does not generate speech information.

Note that the operation of the report assisting device 101 in the present operation example is merely an example. That is, the operation of the report assisting device 101 is not limited to this example. For example, the processing of S206 may not be performed. For example, the processing of either one of S208 and S209 may be performed.

As described above, the report assisting device 101 according to the third example embodiment generates the speech information indicating the position information. Accordingly, for example, the report assisting device 101 can notify the reporter of the position information by speech.

The report assisting device 101 according to the third example embodiment outputs the generated speech information in the communication terminal 10. In a case where a report is made, a communication using telephone conversations is established between the communication terminal 10 and the report destination command system 20. At this time, a speech is output in the communication terminal 10. The output speech is collected by the sound collection device included in the communication terminal 10, and is conveyed to the report destination by using communication using telephone conversations. That is, the report assisting device 101 can automatically convey the position information to the report destination without using communication different from the communication based on report.

The report assisting device 101 according to the third example embodiment transmits, to the report destination of the report, the generated speech information as the speech collected by the communication terminal 10. Accordingly, the report assisting device 101 can convey the generated speech information by using the communication using telephone conversations. That is, the report assisting device 101 can convey the position information to the report destination without using communication different from the communication based on report. In addition, since the report assisting device 101 can transmit the generated speech information to the conveying destination without passing through the sound collection device, it is possible to reduce the possibility that noise is included in the transmitted speech information.

### [Third Modification]

In the first, second, and third example embodiments, an example in which the report assisting device is configured in the communication terminal 10 has been described. The communication terminal 10 may have the function of the report assisting device described above. That is, the communication terminal 10 of the present disclosure may detect a report from the communication terminal 10, the report causing a communication using telephone conversations between the communication terminal 10 and the report destination to be initiated, and acquire the position information of the communication terminal 10 in a case where the report is detected. Then, the communication terminal 10 may perform control to display the acquired position information on the communication terminal 10.

### Configuration Example of Hardware of Report Assisting Device

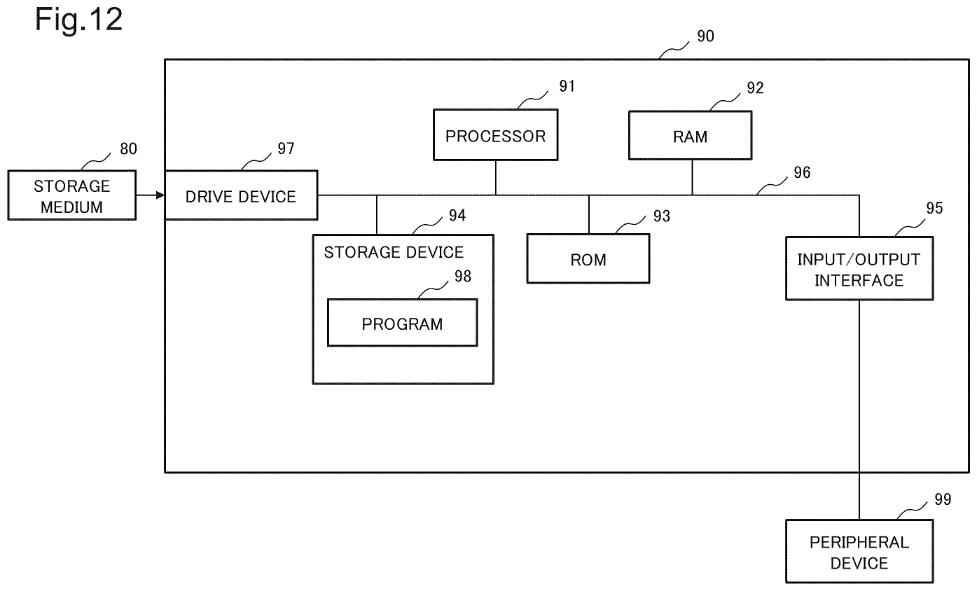

Hardware configuring the report assisting devices of the first, second, and third example embodiments described above will be described. FIG. 12 is a block diagram illustrating an example of a hardware configuration of a computer device that achieves the report assisting device according to each example embodiment. In a computer device 90, the report assisting device and the report assisting method described in each example embodiment and each modification are achieved.

As illustrated in FIG. 12, the computer device 90 includes a processor 91, a random access memory (RAM) 92, a read only memory (ROM) 93, a storage device 94, an input/output interface 95, a bus 96, and a drive device 97. The report assisting device may be achieved by a plurality of electric circuits.

The storage device 94 stores a program (computer program) 98. The processor 91 executes the program 98 of the present report assisting device by using the RAM 92. Specifically, for example, the program 98 includes a program that causes a computer to execute the processing illustrated in FIGS. 3, 7, and 11. The functions of the components of the present report assisting device are implemented in response to the processor 91 executing the program 98. The program 98 may be stored in the ROM 93. The program 98 may be recorded in the storage medium 80 and read using the drive device 97, or may be transmitted from an external device (not illustrated) to the computer device 90 via a network (not illustrated).

The input/output interface 95 exchanges data with a peripheral device (such as a keyboard, a mouse, and a display device) 99. The input/output interface 95 functions as a means for acquiring or outputting data. The bus 96 connects the components.

There are various modifications of the method of achieving the report assisting device. For example, the report assisting device can be achieved as a dedicated device. The report assisting device can be achieved based on a combination of a plurality of devices.

A processing method for causing the storage medium to record the program for achieving each component in the functions of each example embodiment, reading the program recorded in the storage medium as a code, and executing the program in a computer are also included in the scope of each example embodiment. That is, a computer-readable storage medium is also included in the scope of each example embodiment. The storage medium in which the above-described program is recorded and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the storage medium is not limited to a program that executes processing alone, and a program that operates on an operating system (OS) to execute processing in cooperation with other software and functions of an extension board is also included in the scope of each example embodiment.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The above-described example embodiments and modifications can be appropriately combined.

Some or all of the above-described example embodiments may be described as the following supplementary notes, but are not limited to the following.

### Supplementary Note

### [Supplementary Note 1]

A report assisting device including:
a detection means for detecting a report from a communication terminal, the report causing a communication using telephone conversations between the communication terminal and a report destination to be initiated;
an acquisition means for acquiring position information of the communication terminal in a case where the report is detected; and
a display control means for controlling the communication terminal to display the acquired position information.

### [Supplementary Note 2]

The report assisting device according to supplementary note 1, in which
the acquisition means includes
a positioning information acquisition means for acquiring positioning information that is information obtained by determining a location where the communication terminal is positioned; and
an address specifying means for specifying an address where the communication terminal is positioned based on the positioning information, and
the display control means displays, on the communication terminal, the specified address as the position information.

### [Supplementary Note 3]

The report assisting device according to supplementary note 1 or 2, further including
a generation means for generating speech information indicating the position information.

### [Supplementary Note 4]

The report assisting device according to supplementary note 3, further including
a speech output means for outputting the generated speech information in the communication terminal.

### [Supplementary Note 5]

The report assisting device according to supplementary note 3 or 4, further including
a speech transmission means for transmitting the generated speech information, as a speech collected by the communication terminal, to a report destination of the report.

### [Supplementary Note 6]

The report assisting device according to any one of supplementary notes 3 to 5, in which
the display control means displays, on the communication terminal, request information for requesting agreement regarding provision of the position information, and
the generation means generates the speech information in a case where an input of the agreement is received.

### [Supplementary Note 7]

The report assisting device according to any one of supplementary notes 1 to 6, further including
a positioning function activation means for activating, when the report is detected, a function in the communication terminal to determine a location where the communication terminal is positioned in a case where the function is not activated, in which
the acquisition means acquires the position information based on information obtained by determining the location where the communication terminal is positioned.

### [Supplementary Note 8]

The report assisting device according to any one of supplementary notes 1 to 7, in which
the detection means detects a report causing a communication via a telephone line between the communication terminal and the report destination to be initiated.

### [Supplementary Note 9]

A communication terminal including:
a detection means for detecting a report from a communication terminal, the report causing a communication using telephone conversations between the communication terminal and a report destination to be initiated;
an acquisition means for acquiring position information of the communication terminal in a case where the report is detected; and
a display control means for controlling the communication terminal to display the acquired position information.

### [Supplementary Note 10]

A report assisting method including:
detecting a report from a communication terminal, the report causing a communication using telephone conversations between the communication terminal and a report destination to be initiated;
acquiring position information of the communication terminal in a case where the report is detected; and
controlling the communication terminal to display the acquired position information.

### [Supplementary Note 11]

A computer readable storage medium having stored thereon a program that causes a computer to execute:
a process of detecting a report from a communication terminal, the report causing a communication using telephone conversations between the communication terminal and a report destination to be initiated;
a process of acquiring position information of the communication terminal in a case where the report is detected; and
a process of controlling the communication terminal to display the acquired position information.

### Reference Signs List

10 communication terminal
20 command system
100, 101 report assisting device
110 detection unit
120 acquisition unit
130 display control unit
140 positioning function activation unit
150 generation unit
160 speech output unit
170 speech transmission unit
1201 positioning information acquisition unit
1202 address specifying unit

What is claimed is:

1. A report assisting device comprising:
a detector configured to detect a report from a communication terminal, the report causing a communication using telephone conversations between the communication terminal and a report destination to be initiated;
an acquisition circuit configured to acquire position information of the communication terminal in a case where the report is detected; and
a display controller configured to control the communication terminal to display the acquired position information.

2. The report assisting device according to claim 1, wherein
the acquisition circuit includes
a positioning information acquisition circuit configured to acquire positioning information that is information obtained by determining a location where the communication terminal is positioned; and
an address specifying circuit configured to specify an address where the communication terminal is positioned based on the positioning information, and
the display controller displays, on the communication terminal, the specified address as the position information.

3. The report assisting device according to claim 1, further comprising
a generation generator configured to generate speech information indicating the position information.

4. The report assisting device according to claim 3, further comprising
a speech output circuit configured to output the generated speech information in the communication terminal.

5. The report assisting device according to claim 3, further comprising
a speech transmitter configured to transmit the generated speech information, as a speech collected by the communication terminal, to a report destination of the report.

6. The report assisting device according to claim 3, wherein
the display controller displays, on the communication terminal, request information for requesting agreement regarding provision of the position information, and
the generator generates the speech information in a case where an input of the agreement is received.

7. The report assisting device according to claim 1, further comprising
a positioning function activator, when the report is detected, a function in the communication terminal to determine a location where the communication terminal is positioned in a case where the function is not activated, wherein
the acquisition circuit acquires the position information based on information obtained by determining the location where the communication terminal is positioned.

8. The report assisting device according to claim 1, wherein
the detector detects a report causing a communication via a telephone line between the communication terminal and the report destination to be initiated.

9. A communication terminal comprising:
a detector configured to detect a report from a communication terminal, the report causing a communication using telephone conversations between the communication terminal and a report destination to be initiated;
an acquisition circuit configured to acquire position information of the communication terminal in a case where the report is detected; and
a display controller configured to control the communication terminal to display the acquired position information.

10. A report assisting method comprising:
detecting a report from a communication terminal, the report causing a communication using telephone conversations between the communication terminal and a report destination to be initiated;
acquiring position information of the communication terminal in a case where the report is detected; and
controlling the communication terminal to display the acquired position information.

11. A tangible and non-transitory computer readable storage medium having stored thereon a program that causes a computer to execute:
a process of detecting a report from a communication terminal, the report causing a communication using telephone conversations between the communication terminal and a report destination to be initiated;
a process of acquiring position information of the communication terminal in a case where the report is detected; and
a process of controlling the communication terminal to display the acquired position information.
